(19) United States
(12) Patent Application Publication
(10) Pub. No.: US 2026/0254382 A1
(43) Pub. Date: Aug. 27, 2026

(54) ROTOR CONTROL METHOD, ROTOR CONTROL DEVICE, AND NON-TRANSITORY COMPUTER-READABLE STORAGE MEDIUM

(71) Applicant: JIANGSU DONGCHENG TOOLS TECHNOLOGY CO., LTD., NANTONG (CN)

(72) Inventors: Haodong WANG, NANTONG (CN); Jian ZHANG, NANTONG (CN)

(73) Assignee: JIANGSU DONGCHENG TOOLS TECHNOLOGY CO., LTD., NANTONG (CN)

(21) Appl. No.: 18/852,545

(22) PCT Filed: Apr. 11, 2024
(86) PCT No.: PCT/CN2024/087258

§ 371 Date: Sep. 30, 2024

(30) Foreign Application Priority Data
Apr. 12, 2023 (CN) 202310388470.9

(51) Int. Cl. H02P 21/18; H02P 21/22

(52) U.S. Cl. CPC H02P 21/18; H02P 21/22

(57) ABSTRACT

A rotor control method, a rotor control device, and a non-transitory computer-readable storage medium are disclosed. A processing module of the control device is configured to perform the following operations: obtaining both position information and a rotation direction of a rotor; determining a first detection signal and a first control signal based on the position information and the rotation direction, where the first control signal is configured to realize a rotation control of the rotor and the first detection signal is configured to realize a detection of rotor rotation state; and determining whether the rotation direction has changed based on a detection result.

### CROSS REFERENCE TO RELATED APPLICATIONS

This application is a 35 U.S.C. § 371 National Phase conversion of International (PCT) Patent Application No. PCT/CN2024/087258 filed on Apr. 11, 2024, which claims foreign priority to Chinese Patent Application No. 202310388470.9, filed on Apr. 12, 2023, the contents of all of which are hereby incorporated by reference.

### TECHNICAL FIELD

The present disclosure relates to the technical field of electric motors, and in particular to a rotor control method, a rotor control device, and a non-transitory computer-readable storage medium.

### BACKGROUND

Currently, more and more power tools and gardening tools adopt a brushless motor. The brushless motor has strict requirements for working conditions of the tools and the abilities for the tools to start under load or to operate under a heavy-duty low-speed condition. Under many working conditions, an insufficient output torque or an excessive load torque may cause an output shaft of the motor to rebound and thus result in a motor reversal. So far, many tools are still adopting a position sensor solution (i.e., a HALL solution) to address the situation and problem mentioned above. The HALL solution can detect a rotor position in real time and set a motor control signal based on a HALL signal, so as to avoid lost steps. However, adopting the HALL sensor solution may increase an overall size of the product, thereby increasing the cost and the complexity of the assembly process.

Therefore, more and more tools are opting for a position sensor-less control solution (i.e., a sensor-less control solution). Currently, the sensor-less control solution performs a position detection according to the following methods.

### (1) Back Electromotive Force (EMF) Zero Crossing Detection Method

Currently, as illustrated in FIGS. 1(a) and 1(b), the back EMF zero crossing detection is generally performed through determining a relationship between a terminal voltage of a suspended phase and a reference voltage. Taking phase A as an example, a waveform diagram of a winding terminal voltage of the phase A during a wave cycle is illustrated in FIG. 1(a). During periods BC and CB, the phase A is a suspended and the waveform of the terminal voltage of the phase A during the periods BC and CB is further illustrated in FIG. 1(b). When a pulse width modulation (PWM) is turned on, the terminal voltage of the phase A, U_{A}=e_{A}+½U_{DC}, where e_{A} is a back EMF of the phase A and U_{DC} is a DC bus voltage. When U_{A}=½U_{DC}, e_{A}=0, i.e., the back EMF of the phase A crosses zero. When the PWM is turned off, the terminal voltage of the phase A, U_{A}=e_{A}. When U_{A}=0, the back EMF of the phase A crosses zero. Therefore, in a case where the back EMF zero crossing detection is performed when the PWM is turned on, the reference voltage is ½U_{DC}; and in a case where the back EMF zero crossing detection is performed when the PWM is turned off, the reference voltage is OV.

### (2) Dynamic Pulse Detection Method

As illustrated in FIG. 2, due to an effect of magnetic saturation in motor wiring, high frequency pulses are injected into a particular stator coil. That is, the rotor position is detected and determined based on a change in current responses feedback by the high frequency pulses.

However, when the output shaft of the motor rebounds, i.e., the motor reversal occurs, the current sensor-less control solution cannot detect the motor reversal during position detection, and can only perform the position detection in a preset rotation direction. Therefore, an improved control method is desired to overcome the problems in the related art.

### SUMMARY OF THE DISCLOSURE

A rotor control method is provided by some embodiments of the present disclosure. The rotor control method is applied to a control device having a processing module. The control method includes: obtaining, by the processing module, both position information and a rotation direction of a rotor; obtaining, by the processing module, a first control signal based on the position information and the rotation direction, where the rotor rotates according to the first control signal; obtaining, by the processing module, a first detection signal based on the position information and the rotation direction; obtaining, by the processing module, a detection result based on the first detection signal to indicate whether the rotation direction of the rotor has changed.

A rotor control device is further provided by some embodiments of the present disclosure. The rotor control device includes a memory and a processor. The memory stores a computer program that is executable on the processor, and when the computer program is executed by the processor, the processor is caused to perform the rotor control method mentioned above.

A non-transitory computer-readable storage medium is further provided by some embodiments of the present disclosure. The computer-readable storage medium stores non-volatile program code that is executable on a processor, when the non-volatile program code is executed by the processor, the processor is caused to perform the rotor control method mentioned above.

### BRIEF DESCRIPTION OF THE DRAWINGS

The following further illustrates the embodiments of the present disclosure in conjunction with the drawings.

FIG. 1(a) is a waveform diagram of a terminal voltage of phase A during a wave cycle for a motor in the related art.

FIG. 1(b) is a waveform diagram of a terminal voltage of phase A during the phase A is suspended for the motor in the related art.

FIG. 2 is a schematic view of a dynamic pulse detection method.

FIG. 3 is a hardware circuit diagram according to an embodiment of the present disclosure.

FIG. 4 is a waveform diagram illustrating an effect of a magnetic flux of permanent magnet to a stator inductance.

FIG. 5 is a waveform diagram illustrating effects of a magnetic flux of permanent magnet and a stator current to a stator inductance.

FIG. 6 is a schematic view of a synthesized magnetic potential and a control vector sequence (taking a clockwise rotation as an example).

FIG. 7 is a flowchart of a reversal detection and a phase commutation control.

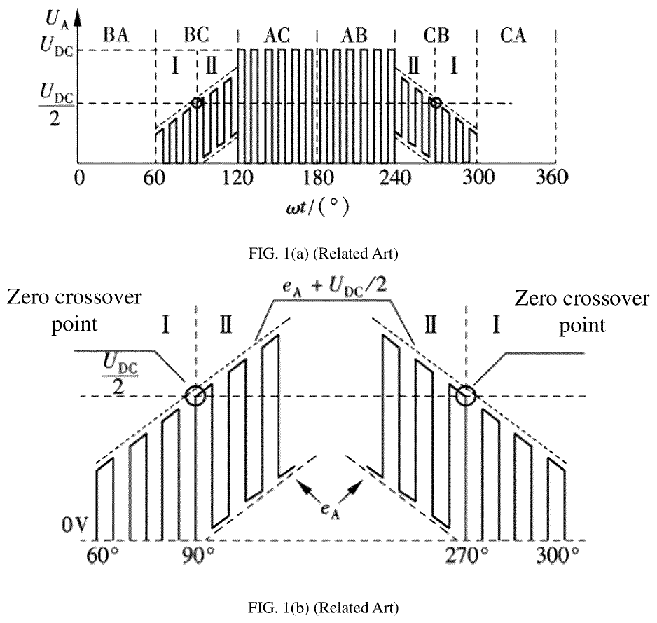

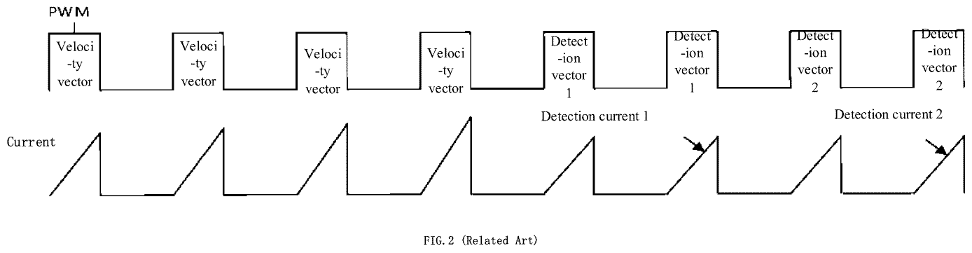

### DETAILED DESCRIPTION

The following further illustrates the present disclosure in conjunction with drawings and embodiments.

The terms used herein are merely for the purposes of describing certain embodiments, instead of limiting the present disclosure.

A control device mentioned in the present disclosure may be a power tool/electrical device. The power tool/electrical device may be a gardening tool, a handheld tool, or any other automation device required to be controlled by an electric motor. Any aforementioned device/tool that is able to adopt the substance of the technical solution described below will fall within the scope of present disclosure. The present disclosure particularly applies to a device that has a rotor reversal detection function.

So far, more and more tools are opting for a position sensor-less control solution (i.e., a sensor-less control solution). However, when an output shaft of a motor rebounds and a motor reversal occurs, a current position detection solution provided by the sensor-less control solution fails to detect the motor reversal, and the current sensor-less control solution can only perform a position detection in a preset rotation direction.

To address the problems in the related art, the present disclosure aims to adopt a sensor-less control that enables the motor to continue outputting a forward torque when the output shaft rebounds and the motor reversal occurs, in a case where the motor starts under load or operates under a heavy-duty low-speed condition, thereby avoiding the motor from losing steps.

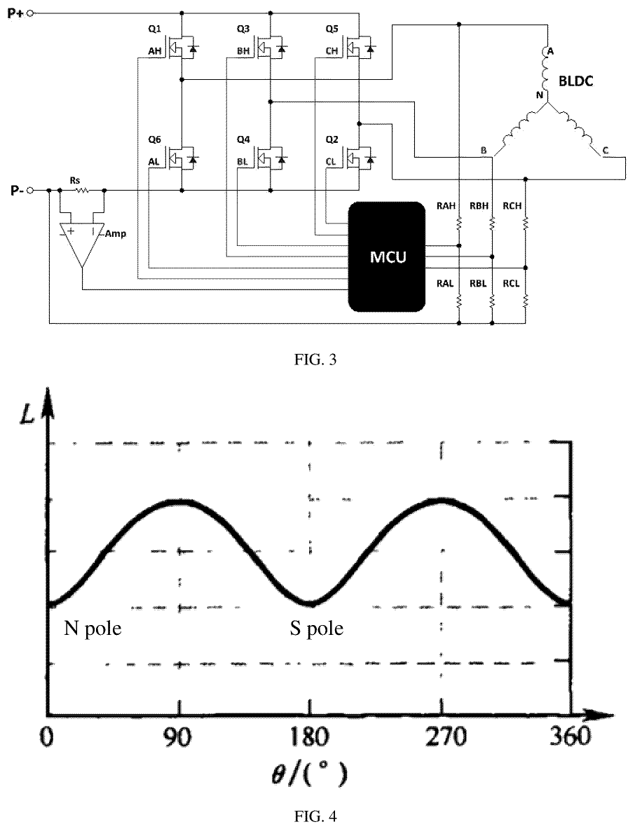

A rotor control method is provided by some embodiments of the present disclosure. The rotor control method is applied to a control device that has a processing module. The processing module is located in a microcontroller unit (MCU). In some embodiments, the method is realized based on a circuit illustrated in FIG. 3, where Q1~Q6 are power devices, RAH, RAL, RBH, RBL, RCH, and RCL are back EMF detection circuits, Rs is a current sampling resistor, Amp is a current amplifier circuit, MCU is a main control chip, BLDC is a brushless DC motor of an overall machine. The motor includes phases A, B, and C. The control method includes the following operations.

The processing module obtains both position information and a rotation direction of the rotor. In some embodiments, the position information may be phase information of the rotor.

The processing module determines a first control signal and a first detection signal based on the position information and the rotation direction. The first control signal is configured to realize a rotation control of the rotor. The first detection signal is configured to realize a detection of a rotor rotation state. In some embodiments, the first control signal includes a first velocity vector. The velocity vector, such as the first velocity vector, is configured to control the rotor to rotate in the rotation direction. The first detection signal includes a first reversal detection vector and a second reversal detection vector. The first reversal detection vector is configured to detect a first current related to the position information of the rotor. The second reversal detection vector is configured to detect a second current related to the position information of the rotor. The first current and the second current are compared to determine whether the motor reversal occurs.

The processing module obtains a detection result based on the first detection signal. The processing module determines whether the rotation direction has changed based on the detection result. When the first current is greater than the second current, the processing module determines that the motor reversal occurs. A second control signal is determined based on the motor reversal, which enables the rotor to perform a phase commutation according to the second control signal. The first control signal is different from the second control signal.

In the present disclosure, during the rotation of the rotor, the sensor-less control is adopted to determine the corresponding detection signal based on both the position information and the rotation direction of the rotor and further accurately determine whether the motor reversal occurs based on the detection result, thereby effectively improving the accuracy of the detection.

In some embodiments, in response to the processing module obtaining the location information and the rotation direction of the rotor, determining, by the processing module, the first control signal and the first detection signal based on the position information and the rotation direction includes the following operations: determining a working status of the rotor, i.e., determining whether the rotor is in a control stage; in response to the rotor being not in the control stage, determining whether the rotor is in a detection stage; in response to the rotor being in the detection stage, detecting a detection current based on the first detection signal; determining whether the detection current meets a preset condition; and in response to the detected currents meeting the preset condition, performing a phase commutation of motor.

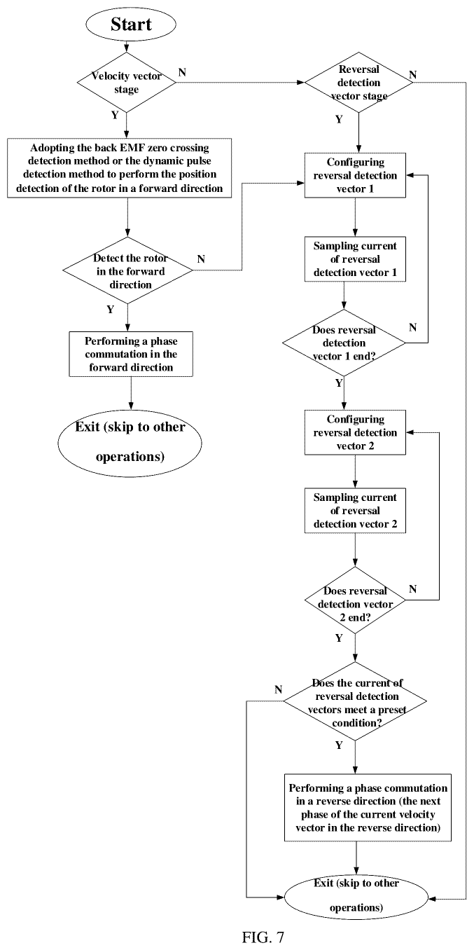

In some embodiments, as illustrated in FIG. 7, during the operation of the rotor, the control method includes the following operations: determining whether the rotor is in the control stage; in response to the rotor being not in the control stage, determining whether the rotor is in the detection stage; in response to the rotor being in the detection stage, determining to detect a first current based on a first detection signal; determining whether a detection of the first current based on the first detection signal has ended; in response to determining that the detection of the first current has not ended, continuing detecting the first detection signal; in response to determining that the detection of the first current has ended, configuring a second detection signal to detect a second current and determining whether the first current and the second current meet a preset condition; in response to the first current and the second current meeting the preset condition, performing a phase commutation of motor.

In response to the rotor being in the control stage, adopting the back EMF zero crossing detection method or the dynamic pulse detection method to perform the position detection of the rotor in a forward direction. In response to the rotor being detected in the forward direction, performing a phase commutation in the forward direction. In response to not detecting the rotor in the forward direction, detecting a first current based on the first detection signal to and then proceeding with the detection stage mentioned above. In response to determining that the detected currents, i.e., the first current and the second current, meet the preset condition, performing a phase commutation of motor in a reverse direction.

The above process adjusts the phase when the rotor reversal occurs, which ensures the motor to continue outputting the positive torque, thereby avoiding the motor from losing steps and improving an operational stability of the overall machine.

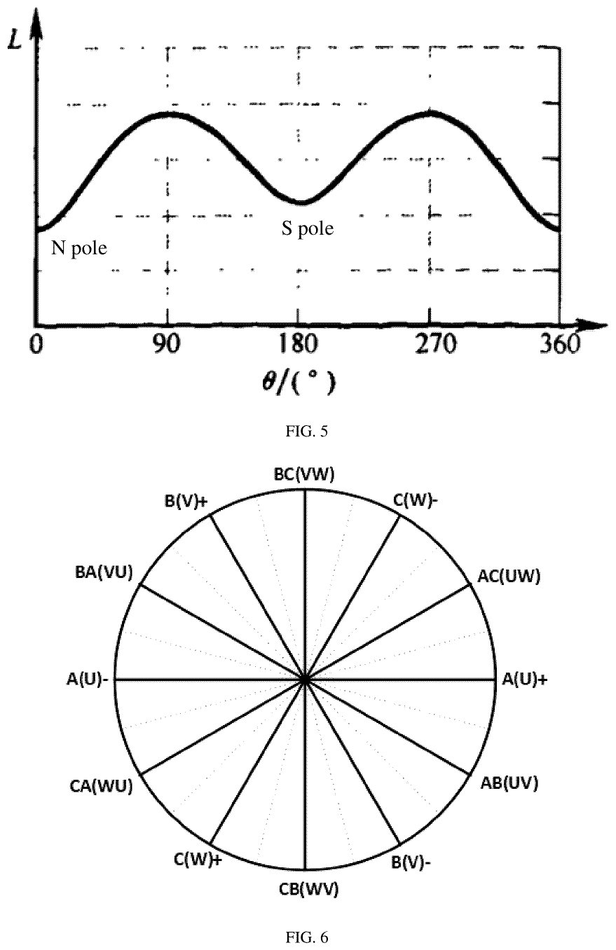

In some embodiments, the dynamic pulse detection method, specifically a short-term pulse method, is adopted to perform the position detection of the rotor. The principle of the short-term pulse method is illustrated in the following. A stator core of the brushless DC motor (BLDCM) is wounded with a current-carrying coil. When current is passed through the coil, a certain amount of magnetic flux is generated in the core. When an external magnetic field is applied to the motor winding along with the current, a degree of saturation of the stator core is determined by both the external magnetic field and the magnetic flux generated by the current in the winding. A coil inductance or winding inductance is not constant and may vary with the degree of saturation of the stator core. Therefore, in a case where the motor is still or rotates in a low speed, when a direction of the magnetic flux generated by a permanent magnet is consistent with a direction of the magnetic flux generated by a stator current, a magnetization effect occurs, i.e., the degree of saturation of the stator core increases and the winding inductance decreases; otherwise, the degree of saturation of the stator core decreases and the winding inductance increases. FIG. 4 and FIG. 5 provide the waveform diagrams illustrating the variation pattern of the stator winding inductance. That is to say, a relative position between the rotor and the stator may be directly reflected in the value of inductance.

A voltage formula of the motor is defined as: U=R*i+L*(di/dt)+E, where U is bus voltage, R is motor winding internal resistance, i is armature current, L is stator winding inductance, and E is back EMF of the motor. When the motor is still or rotates in a low speed, the back EMF of the motor is almost zero. In addition, since the motor winding internal resistance R is relatively small in practice, a voltage drop across the motor winding due to the resistance R is negligible compared to the DC bus voltage applied to the stator winding. Therefore, the formula is simplified as follows: U=L*(di/dt)≈L*Δi/Δt.

According to the formula, when U is constant, L and Δi are inversely proportional, i.e., the larger L, the smaller Δi, and vice versa. Additionally, Δi and Δt are directly proportional, i.e., the larger Δt, the larger Δi. In practice, the value of Δt is limited by a maximum current that the motor driver can handle.

The present disclosure adopts a short-term pulse method, which involves the principle of the stator core saturation effect. Through selecting six short-term voltage detection pulses of an appropriate width and applying voltage to the motor stator winding in sequence according to a corresponding energizing order, current values are sampled and compared to determine an electrical angle region of the rotor. Each electrical cycle of the motor is 360° electrical angle, with each 60° electrical angle representing one conduction interval, referred to as a sector herein. There are six sectors in total. To facilitate description and simplify the analysis, a magnetic potential vector diagram is illustrated in FIG. 6.

As illustrated in FIG. 6, when the rotor is in position BA, a vector AC needs to be applied to achieve a clockwise rotation, i.e., turning on Q1 and Q2. In this case, the AC vector is defined as a velocity vector. There are two methods to determine the position information of the rotor. The first method is detecting the back EMF during the application of the velocity vector. When the back EMF crosses zero, a phase commutation point is determined by a delay of 0 to 30° electrical angle. The other method is inserting rotor position detection vectors during the application of the velocity vector. In this case, the inserted rotor position detection vectors are vectors BA and BC. When the rotor is within a 30° interval between vectors BA and B+, the current vector BA is greater than the current vector BC (i_{BA}>i_{BC}). When the rotor position is within a 30° interval between vectors B+ and BC, the current vector BA is smaller than the current vector BC (i_{BA}<i_{BC}). At this point, the velocity vector is commutated from AC to AB, i.e., turning on Q1 and Q4. In this way, one phase commutation operation is completed and the detection vector is then updated to BC and AC.

According to the two forward rotation control methods mentioned above, reversal detection vectors are inserted. When the current of reversal detection vectors meets certain conditions, it is determined that the rotor reversal occurs. A specific explanation is provided as follows.

In order to obtain the control signal that includes the velocity vector, both the position information and the rotation direction of the rotor are required to determine the current position of the rotor. For example, the rotor may be in the position BA (within a 60° interval from A− to B+ in the vector diagram illustrated in FIG. 6) and the rotation direction may be further determined to be in the clockwise direction. In this way, the corresponding control signal is thus obtained. The forward direction is referred to as the clockwise direction. When the motor is rotating in the forward direction, a two-phase velocity vector AC is applied. However, due to, for example, an insufficient output torque or an excessive load torque, the output shaft rebounds and the motor reversal occurs. In this case, the rotor does not rotate forward from position A− to position B+ as expected but instead reverses to position C+. During the above process, the reversal detection vectors AC and BC are determined based on the position information, i.e., position BA, and the rotation direction, i.e., forward direction. Further, detection currents that correspond to the vectors AC and BC may be obtained based on the vectors AC and BC and thus, whether the motor reversal occurs may be determined based on the two detection currents. In some embodiments, four combinations of the reversal detection vectors may be inserted, as illustrated in Tables 1 to 4 below. For example, when two-phase reversal detection vectors are adopted, one reversal detection vector is the same as the velocity vector, which allows the detected velocity vector current to be directly used. The other reversal detection vector is the next phase of the velocity vector in the reverse direction, which in this case is BC. When the motor is operating normally in the forward direction, an angle between the rotor and the vector BC is smaller than an angle between the rotor and the velocity vector (also as the detection vector), so i_{AC}<i_{BC}. However, when the rotor starts to rotate in the reverse direction, the rotor reverses from position A− to position C+ and after passing the C+position, the angle between the rotor and the vector BC becomes larger than the angle between the rotor and the velocity vector (also as the detection vector), so i_{AC}>i_{BC}. In this way, when the velocity vector AC continues to be applied (since the conventional method fails to detect the motor reversal), the motor is further reversed, thereby creating a vicious cycle. The embodiments of the present disclosure may realize an accurate detection the occurrence of motor reversal. Therefore, the velocity vector is switched backward from AC to BC, which allows a forward torque to remain being applied from the perspective of the rotor and thus enables the motor to maintain the forward rotation. The present disclosure ensures that when the motor reversal occurs, the motor continues outputting a forward torque through adjusting the phase, thereby avoiding the motor from losing steps.

In some embodiments, as illustrated in Tables 1 to 4, four combinations of the velocity vectors and the detection vectors may be provided: a first combination of two-phase forward velocity vector and two-phase reversal detection vectors, a second combination of two-phase forward velocity vector and three-phase reversal detection vectors, a third combination of three-phase forward velocity vector and two-phase reversal detection vectors, and a fourth combination of three-phase forward velocity vector and three-phase reversal detection vectors.

Table 1 indicates the first combination of two-phase forward velocity vector and two-phase reversal detection vectors.

TABLE 1

| | Rotor | | | | | | |
|---|---|---|---|---|---|---|---|
| Rotor | reverse | | | | | | |
| forward | rotation | | | | Velocity | Detection | Detection |
| rotation | interval | Forward | Reversal | Reversal | vector | current | current |
| interval | (counter- | velocity | detection | detection | after | (forward | (reverse |
| (clockwise) | clockwise) | vector | vector 1 | vector 2 | reversal | rotation) | rotation) |
| A−~B+ | A−~ C+ | AC | AC | BC | BC | i_{AC} < i_{BC} | i_{AC} > i_{BC} |
| (BA ± 30°) | (CA ± 30°) | | | | | | |
| B+~C− | B+~A− | AB | AB | AC | AC | i_{AB} < i_{AC} | i_{AB} > i_{AC} |
| (BC ± 30°) | (BA ± 30°) | | | | | | |
| C−~ A+ | C−~B+ | CB | CB | AB | AB | i_{CB} < i_{AB} | i_{CB} > i_{AB} |
| (AC ± 30°) | (BC+30°) | | | | | | |
| A+−~ B− | A+−~C− | CA | CA | CB | CB | i_{CA} < i_{CB} | i_{CA} > i_{CB} |
| (AB ± 30°) | (AC ± 30°) | | | | | | |
| B−~ C+ | B−~A+ | BA | BA | CA | CA | i_{BA} < i_{CA} | i_{BA} > i_{CA} |
| (CB ± 30°) | (AB ± 30°) | | | | | | |
| C+~A− | C+~B− | BC | BC | BA | BA | i_{BC} < i_{BA} | i_{BC} > i_{BA} |
| (CA ± 30°) | (CB ± 30°) | | | | | | |

Table 2 indicates the second combination of two-phase forward velocity vector and three-phase reversal detection vectors.

TABLE 2

| | Rotor | | | | | | |
|---|---|---|---|---|---|---|---|
| | reverse | | | | | | |
| forward | rotation | | | | Velocity | Detection | Detection |
| rotation | interval | Forward | Reversal | Reversal | vector | current | current |
| interval | (counter- | velocity | detection | detection | after | (forward | (reverse |
| (clockwise) | clockwise) | vector | vector 1 | vector 2 | reversal | rotation) | rotation) |
| BA~BC | BA~CA | AC | A+ | C− | BC | i_{A+} < i_{C-} | i_{A+} > i_{C-} |
| (B+ ± 30°) | (A− ± 30°) | | | | | | |
| BC~AC | BC~BA | AB | B− | A+ | AC | i_{B-} < i_{A+} | i_{B-} > i_{A+} |
| (C− ± 30°) | (B+ ± 30°) | | | | | | |
| AC~AB | AC~BC | CB | C+ | B− | AB | i_{C+} < i_{B-} | i_{C+} > i_{B-} |
| (A+ ± 30°) | (C− ± 30°) | | | | | | |
| AB~CB | AB~AC | CA | A− | C+ | CB | i_{A-} < i_{C+} | i_{A-} > i_{C+} |
| (B− ± 30°) | (A+ ± 30°) | | | | | | |
| CB~CA | CB~AB | BA | B+ | A− | CA | i_{B+} < i_{A-} | i_{B+} > i_{A-} |
| (C+ ± 30°) | (B− ± 30°) | | | | | | |
| CA~BA | CA~CB | BC | C− | B+ | BA | i_{C-} < i_{B+} | i_{C-} > i_{B+} |
| (A− ± 30°) | (C+ ± 30°) | | | | | | |

Table 3 indicates the third combination of three-phase forward velocity vector and two-phase reversal detection vectors.

TABLE 3

| | Rotor | | | | | | |
|---|---|---|---|---|---|---|---|
| Rotor | reverse | | | | | | |
| forward | rotation | | | | Velocity | Detection | Detection |
| rotation | interval | Forward | Reversal | Reversal | vector | current | current |
| interval | (counter- | velocity | detection | detection | after | (forward | (reverse |
| (clockwise) | clockwise) | vector | vector 1 | vector 2 | reversal | rotation) | rotation) |
| A−~B+ | A−~C+ | C− | AC | BC | B+ | i_{AC} < i_{BC} | i_{AC} > i_{BC} |
| (BA ± 30°) | (CA ± 30°) | | | | | | |
| B+~C− | B+~A− | A+ | AB | AC | C− | i_{AB} < i_{AC} | i_{AB} > i_{AC} |
| (BC ± 30°) | (BA ± 30°) | | | | | | |
| C−~A+ | C−~ B+ | B− | CB | AB | A+ | i_{CB} < i_{AB} | i_{CB} > i_{AB} |
| (AC ± 30°) | (BC ± 30°) | | | | | | |
| A+−~ B− | A+−~ C− | C+ | CA | CB | B− | i_{CA} < i_{CB} | i_{CA} > i_{CB} |
| (AB ± 30°) | (AC ± 30°) | | | | | | |
| B−~C+ | B−~A+ | A− | BA | CA | C+ | i_{BA} < i_{CA} | i_{BA} > i_{CA} |
| (CB ± 30°) | (AB ± 30°) | | | | | | |
| C+~A− | C+~B− | B+ | BC | BA | A− | i_{BC} < i_{BA} | i_{BC} > i_{BA} |
| (CA ± 30°) | (CB ± 30°) | | | | | | |

Table 4 indicates the fourth combination of three-phase forward velocity vector and three-phase reversal detection vectors.

TABLE 4

| | Rotor | | | | | | |
|---|---|---|---|---|---|---|---|
| Rotor | reverse | | | | | | |
| forward | rotation | | | | Velocity | Detection | Detection |
| rotation | interval | Forward | Reversal | Reversal | vector | current | current |
| interval | (counter- | velocity | detection | detection | after | (forward | (reverse |
| (clockwise) | clockwise) | vector | vector 1 | vector 2 | reversal | rotation) | rotation) |
| BA~BC | BA~CA | A+ | A+ | C− | C− | i_{A+} < i_{C-} | i_{A+} > i_{C-} |
| (B+ ± 30°) | (A− ± 30°) | | | | | | |
| BC~AC | BC~BA | B− | B− | A+ | A+ | i_{B-} < i_{A+} | i_{B-} > i_{A+} |
| (C− ± 30°) | (B+ ± 30°) | | | | | | |
| AC~AB | AC~BC | C+ | C+ | B− | B− | i_{C+} < i_{B-} | i_{C+} > i_{B-} |
| (A+ ± 30°) | (C− ± 30°) | | | | | | |
| AB~CB | AB~AC | A− | A− | C+ | C+ | i_{A-} < i_{C+} | i_{A-} > i_{C+} |
| (B− ± 30°) | (A+ ± 30°) | | | | | | |
| CB~CA | CB~AB | B+ | B+ | A− | A− | i_{B+} < i_{A-} | i_{B+} > i_{A-} |
| (C+ ± 30°) | (B− ± 30°) | | | | | | |
| CA~BA | CA~CB | C− | C− | B+ | B+ | i_{C-} < i_{B+} | i_{C-} > i_{B+} |
| (A− ± 30°) | (C+ ± 30°) | | | | | | |

A rotor control method is provided by some embodiments of the present disclosure. The method is performed by a processing module of a device and includes: obtaining both position information and a rotation direction of a rotor; determining first control signal and first detection signal based on the position information and the rotation direction, where the first control signal is configured to realize a rotation control of the rotor and the first detection signal is configured to realize a detection of rotor rotation state; and determining whether the rotation direction has changed based on the detection result. The present disclosure adopts a sensor-less control during the rotation of the rotor to determine the corresponding detection signal based on both the position information and the rotation direction of the rotor and then determine whether the motor reversal occurs based on the detection result, thereby effectively improving the accuracy of the detection. The present disclosure ensures that when the motor reversal occurs, the motor continues outputting the forward torque through adjusting the phase, thereby avoiding the motor from losing steps.

A rotor control device is further provided by some embodiments of the present disclosure. The device is configured to perform the method above and the rotor control device includes the following modules.

A first obtaining module is configured to obtain both position information and a rotation direction of the rotor.

A first processing module is configured to determine a first control signal based on the position information and the rotation direction. The first control signal is configured to realize a rotation control of the rotor. In some embodiments, the first control signal includes a first velocity vector. The velocity vector, such as the first velocity vector, is configured to control the rotor to rotate in the rotation direction.

A second obtaining module is configured to obtain a first detection signal based on the position information and the rotation direction. The first detection signal is configured to realize a detection of a rotor rotation state. The first detection signal includes a first reversal detection vector and a second reversal detection vector. The first reversal detection vector is configured to detect a first current related to the position information of the rotor. The second reversal detection vector is configured to detect a second current related to the position information of the rotor. The second obtaining module is further configured to determine whether the motor reversal occurs through comparing the first current and the second current.

A second processing module is configured to obtain a detection result based on the first detection signal, where the detection result is configured to indicate whether the rotation direction of the rotor has changed; determining whether to perform a phase commutation in a different rotation direction based on the detection result; in response to the first current being greater than the second current, determining that the reversal state occurs; determining a second control signal based on the motor reversal, which enables the rotor to perform a phase commutation according to the second control signal. The first control signal and the second control signal are different.

In the present disclosure, during the rotation of the rotor, the sensor-less control is adopted to determine the corresponding detection signal based on both the position information and the rotation direction of the rotor and further accurately determine whether the motor reversal occurs based on the detection result, thereby effectively improving the accuracy of the detection.

In some embodiments, the determining the first control signal and the first detection signal based on the position information and the rotation direction includes the following operations: determining whether the rotor is currently in a control stage; in response to the rotor being not in the control stage, determining whether the rotor is in a detection stage; in response to the rotor being in the detection stage, detecting a detection current based on the first detection signal; determining whether the detection current meets a preset condition; and in response to the detection current meeting the preset condition, performing a phase commutation.

As illustrated in FIG. 7, during the operation of the rotor, the above process further includes the following operations: determining whether the rotor is in the control stage; in response to the rotor being not in the control stage, determining whether the rotor is in the detection stage; in response to the rotor being in the detection stage, determining to detect a first current based on a first detection signal; determining whether the first current has ended based on the first detection signal; in response to determining that the first current has not ended based on the first detection signal, continuing detecting the first detection signal; in response to determining that the first current has ended based on the first detection signal, configuring a second detection signal to detect a second current and determining whether the first current and the second current meet a preset condition; in response to the first current and the second current meeting the preset condition, performing a phase commutation.

In response to the rotor being in the control stage, adopting the back EMF zero crossing detection method or the dynamic pulse detection method to perform the position detection of the rotor in a forward direction. In response to detecting the rotor in the forward direction, performing a phase commutation in the forward direction. In response to not detecting the rotor in the forward direction, detecting a first current based on the first detection signal to and then proceeding with the detection stage mentioned above. In response to determining that the detected currents, i.e., the first current and the second current, meet the preset condition, performing a phase commutation in a reverse direction.

The above process adjusts the phase when the rotor reversal occurs, which ensures the motor to continue outputting the positive torque, thereby avoiding the motor from losing steps.

Some embodiments of the present disclosure perform the following operations through the processing module of the device: obtaining both position information and a rotation direction of a rotor; determining a first control signal and a first detection signal based on the position information and the rotation direction, where the first control signal is configured to realize a rotation control of the rotor and the first detection signal is configured to realize a detection of rotor rotation state; and determining whether the rotation direction has changed based on the detection result. The present disclosure adopts a sensor-less control during the rotation of the rotor to determine the corresponding detection signal based on both the position information and the rotation direction of the rotor and then determine whether the motor reversal occurs based on the detection result, thereby effectively improving the accuracy of the detection. The present disclosure ensures that when the motor reversal occurs, the motor continues outputting the forward torque through adjusting the phase, thereby avoiding the motor from losing steps.

A rotor control device is further provided by some embodiments of the present disclosure. The rotor control device includes a memory and a processor. The memory stores a computer program that is executable on the processor. When the computer program is executed by the processor, the processor is caused to perform the method.

A non-transitory computer-readable storage medium is further provided by some embodiments of the present disclosure. The computer-readable storage medium stores non-volatile program code that is executable on a processor. When the non-volatile program code is executed by the processor, the processor is caused to perform the method.

Any ordinary skilled in the art can clearly understand that, for the ease and simplicity of description, specific operations of the aforementioned device may refer to a corresponding process described in the method embodiments above, which will not be repeated herein.

The functions mentioned above may be stored in a computer-readable storage medium when the functions are realized in the form of a software functional unit and are sold or used as an individual product. Based on such understanding, the essence of the technical solutions of the present disclosure, i.e., a part of the technical solutions that contributes to the related art, or a part of the technical solutions may be embodied in the form of a software product. The computer software product is stored in a storage medium that includes a plurality of instructions configured to cause a computer device (which may be a personal computer, a server, or a network device, etc.) to perform all or part of the operations of the method described in various embodiments of the present disclosure. The aforementioned storage medium may include: a USB flash drive, a removable hard disk, a read-only memory (ROM), a random access memory (RAM), a magnetic disk, or a CD-ROM, and any other medium that can store program code.

Finally, it should be noted that the above mentioned embodiments are only specific embodiments of the present disclosure, which are used to illustrate, rather than limiting, the technical solutions of the present disclosure, and the scope of the present disclosure is not limited thereto. Although the above mentioned embodiments clearly illustrate the present disclosure, the ordinary skilled in the art should understand that, any skilled person familiar with the technical field of the present disclosure may still modify or easily come up with changes to the technical solutions described in the aforementioned embodiments within the technical scope of the present disclosure, or to make equivalent substitutions for some of the technical features therein. Any modifications, changes, or substitutions, which do not make the essence of the corresponding technical solutions out of the spirit and scope of the technical solutions of the embodiments of the present disclosure, shall be covered by the scope of the present disclosure. Therefore, the scope of the present disclosure shall be subject to the scope defined by the claims.

1-10. (canceled)

11. A rotor control method, applied to a control device having a processing module, and comprising:
obtaining, by the processing module, both position information and a rotation direction of a rotor;
obtaining, by the processing module, a first control signal based on the position information and the rotation direction, wherein the rotor rotates according to the first control signal and the first control signal comprises at least a first velocity vector;
obtaining, by the processing module, a first detection signal based on the position information and the rotation direction, wherein the first detection signal comprises at least a first reversal detection vector and a second reversal detection vector, and each of the first reversal detection vector and the second reversal detection vector is different from the first velocity vector; and
obtaining, by the processing module, a detection result based on the first detection signal to indicate whether the rotation direction of the rotor has changed.

12. The rotor control method as claimed in claim 11, after the obtaining, by the processing module, both position information and a rotation direction of a rotor, further comprising:
determining a working status of the rotor;
in response to the working status of the rotor indicating that the rotor is in a detection stage, obtaining the first detection signal;
detecting a detection current based on the first detection signal;
determining whether the detection current meet a preset condition; and
in response to the detection current meeting the preset condition, performing a phase commutation.

13. The rotor control method as claimed in claim 11, wherein the first velocity vector is configured to control the rotor to rotate in the rotation direction.

14. The rotor control method as claimed in claim 11, wherein the first reversal detection vector is configured to detect a first current related to the position information of the rotor, the second reversal detection vector is configured to detect a second current related to the position information of the rotor, and the detection result is obtained based on the first current and the second current.

15. The rotor control method as claimed in claim 14, after the obtaining, by the processing module, a detection result, further comprising:
in response to the detection result indicating that the first current is greater than the second current, determining that the rotation direction of the rotor has changed; and
generating a second control signal based on a changed rotation direction to control the rotor to rotate according to the second control signal.

16. The rotor control method as claimed in claim 11, after the obtaining, by the processing module, both position information and a rotation direction of a rotor, further comprising:
determining a working status of the rotor;
in response to the working status of the rotor indicating that the rotor is in a control stage, performing a position detection of the rotor in a forward direction;
in response to the rotor being detected in the forward direction, performing a phase commutation in the forward direction.

17. The rotor control method as claimed in claim 16, wherein the position detection is performed through a back electromotive force (EMF) zero crossing detection method or a dynamic pulse detection method.

18. The rotor control method as claimed in claim 16, after the, in response to the working status of the rotor indicating that the rotor is in a control stage, performing a position detection of the rotor in a forward direction, further comprising:
in response to the rotor being not detected in the forward direction, obtaining the first detection signal;
detecting a detection current based on the first detection signal;
determining whether the detection current meets a preset condition; and
in response to the detection current meeting the preset condition, performing a phase commutation in a reverse direction.

19. The rotor control method as claimed in claim 18, after the obtaining, by the processing module, both position information and a rotation direction of a rotor, further comprising:
determining a working status of the rotor;
in response to the working status of the rotor indicating that the rotor is in a detection stage, determining to detect a first current based on a first detection signal;
in response to determining that a detection of the first current has ended, configuring a second detection signal to detect a second current;
determining whether the first current and the second current meet a preset condition; and
in response to the first current and the second current meeting the preset condition, performing a phase commutation in a reverse direction.

20. The rotor control method as claimed in claim 11, wherein the position information is phase information of the rotor.

21. A rotor control device, comprising a memory and a processor, wherein the memory stores a computer program that is executable on the processor, and when the computer program is executed by the processor, the processor is caused to perform a rotor control method;
wherein the rotor control method comprises:
obtaining both position information and a rotation direction of a rotor;
obtaining a first control signal based on the position information and the rotation direction, wherein the rotor rotates according to the first control signal and the first control signal comprises at least a first velocity vector;
obtaining a first detection signal based on the position information and the rotation direction, wherein the first detection signal comprises at least a first reversal detection vector and a second reversal detection vector, and each of the first reversal detection vector and the second reversal detection vector is different from the first velocity vector; and
obtaining a detection result based on the first detection signal to indicate whether the rotation direction of the rotor has changed.

22. The rotor control device as claimed in claim 21, wherein after the obtaining, by the processing module, both position information and a rotation direction of a rotor, the rotor control method further comprises:
determining a working status of the rotor;
in response to the working status of the rotor indicating that the rotor is in a detection stage, obtaining a first detection signal;
detecting a detection current based on the first detection signal;
determining whether the detection current meets a preset condition; and
in response to the detection current meeting the preset condition, performing a phase commutation in a reverse direction.

23. The rotor control device as claimed in claim 21, wherein the first velocity vector is configured to control the rotor to rotate in the rotation direction.

24. The rotor control device as claimed in claim 21, wherein the first reversal detection vector is configured to detect a first current related to the position information of the rotor, the second reversal detection vector is configured to detect a second current related to the position information of the rotor, and the detection result is obtained based on the first current and the second current.

25. The rotor control device as claimed in claim 24, wherein after the obtaining, by the processing module, a detection result, the rotor control method further comprises:
in response to the detection result indicating that the first current is greater than the second current, determining that the rotation direction of the rotor has changed; and
generating a second control signal based on a changed rotation direction to control the rotor to rotate according to the second control signal.

26. The rotor control device as claimed in claim 21, wherein after the obtaining, by the processing module, both position information and a rotation direction of a rotor, the rotor control method further comprises:
determining a working status of the rotor;
in response to the working status of the rotor indicating that the rotor is in a control stage, performing a position detection of the rotor in a forward direction;
in response to the rotor being detected in the forward direction, performing a phase commutation in the forward direction.

27. The rotor control device as claimed in claim 26, wherein the position detection is performed through a back electromotive force (EMF) zero crossing detection method or a dynamic pulse detection method.

28. The rotor control device as claimed in claim 26, wherein after the, in response to the working status of the rotor indicating that the rotor is in a control stage, performing a position detection of the rotor in a forward direction, the rotor control method further comprises:
in response to the rotor being not detected in the forward direction, obtaining the first detection signal;
detecting a detection current based on the first detection signal;
determining whether the detection current meets a preset condition; and
in response to the detection current meeting the preset condition, performing a phase commutation in a reverse direction.

29. The rotor control device as claimed in claim 21, wherein after the obtaining, by the processing module, both position information and a rotation direction of a rotor, the rotor control method further comprises:
determining a working status of the rotor;
in response to the working status of the rotor indicating that the rotor is in a detection stage, determining to detect a first current based on a first detection signal;
in response to determining that a detection of the first current has ended, configuring a second detection signal to detect a second current;
determining whether the first current and the second current meet a preset condition; and
in response to the first current and the second current meeting the preset condition, performing a phase commutation in a reverse direction.

30. A non-transitory computer-readable storage medium, wherein the computer-readable storage medium stores non-volatile program code that is executable on a processor, when the non-volatile program code is executed by the processor, the processor is caused to perform a rotor control;
wherein the rotor control method comprises:
obtaining both position information and a rotation direction of a rotor;
obtaining a first control signal based on the position information and the rotation direction, wherein the rotor rotates according to the first control signal and the first control signal comprises at least a first velocity vector;
obtaining a first detection signal based on the position information and the rotation direction, wherein the first detection signal comprises at least a first reversal detection vector and a second reversal detection vector, and each of the first reversal detection vector and the second reversal detection vector is different from the first velocity vector; and
obtaining a detection result based on the first detection signal to indicate whether the rotation direction of the rotor has changed.
